(19) United States
(12) Patent Application Publication
(10) Pub. No.: US 2025/0078399 A1
(43) Pub. Date: Mar. 6, 2025

(54) IMAGE RENDERING METHOD AND DEVICE

(71) Applicant: Smarter Silicon (Shanghai) Technologies Co., Ltd., Shanghai (CN)

(72) Inventors: Zhuojin SUN, Shanghai (CN); Huafei QI, Shanghai (CN)

(21) Appl. No.: 18/812,736

(22) Filed: Aug. 22, 2024

(30) Foreign Application Priority Data
Aug. 30, 2023 (CN) 202311110683.1

(51) Int. Cl. G06T 15/40

(52) U.S. Cl. CPC G06T 15/40

(57) ABSTRACT

An image rendering method includes receiving one or more input models; filtering the one or more input models to obtain one or more filtered input models, a plurality of filtering parameters used in the filtering being established based on data that have an input model already been eliminated in a rendered image frame; and rendering a current image frame based on the one or more filtered input models.

### CROSS-REFERENCES TO RELATED APPLICATION

This application claims priority to Chinese Patent Application No. 202311110683.1 filed on Aug. 30, 2023, the entire content of which is incorporated herein by reference.

### FIELD OF TECHNOLOGY

The present disclosure relates to the field of image rendering technology and, more specifically, to an image rendering method and device.

### BACKGROUND

During image rendering, the model data input to the rendering pipeline generally has a lot of redundancy. In some cases, the model data actually associated with the image rendering content accounts for less than 50% of the input model data. In order to obtain valid data from the model data, when rendering each frame of the image through the rendering pipeline, a series of culling operations are required to eliminate invalid input data.

However, even if there are only slight changes between two adjacent frames and the to-be-culled data is nearly the same, when each frame is rendered, there is a need to obtain the complete input data and perform culling operations, which results in low rendering efficiency.

### SUMMARY

One aspect of this disclosure provides an image rendering method. An image rendering method includes receiving one or more input models; filtering the one or more input models to obtain one or more filtered input models, a plurality of filtering parameters used in the filtering being established based on data that have an input model already been eliminated in a rendered image frame; and rendering a current image frame based on the one or more filtered input models.

Another aspect of the present disclosure provides an image rendering device. The image rendering device includes computer readable storage medium storing computer instructions, when executed by one or more processors, the computer instructions implement the image rendering method as described herewith.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of an image rendering method in related technology.

FIG. 2 is a flowchart of an exemplary image rendering method according to some embodiments of the present disclosure.

FIG. 3 is a schematic structural diagram of backface culling according to some embodiments of the present disclosure.

FIG. 4 is a schematic structural diagram of filtering parameters in the backface culling process according to some embodiments of the present disclosure.

FIG. 5 is a schematic structural diagram of frustum culling according to some embodiments of the present disclosure.

FIG. 6 is a schematic structural diagram of filtering parameters in the frustum culling process according to some embodiments of the present disclosure.

FIG. 7 is a flowchart of an exemplary first rendering model filtering method according to some embodiments of the present disclosure.

FIG. 8 is a flowchart of an exemplary second rendering model filtering method according to some embodiments of the present disclosure.

FIG. 9 is a flowchart of an exemplary rasterization culling method according to some embodiment of the present disclosure.

FIG. 10 is a schematic structural diagram of an exemplary image render device according to some embodiments of the present disclosure.

FIG. 11 is a schematic hardware diagram of an exemplary electronic device according to some embodiments of the present disclosure.

### DETAILED DESCRIPTION

The technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, as long as they do not conflict with each other.

In the present disclosure, the terms “first,” “second,” and “third” are only used for descriptive purposes, and should not be understood as indicating or implying relative importance or implying the number of indicated technical features. Thus, a feature described with “first,” “second,” and “third” may expressly or implicitly include at least one of this feature, and the order may be changed according to the actual situations.

Those skilled in the art should understand that unless otherwise defined, all terms (including technical terms and scientific terms) used herein have the same meanings as those of ordinary skill in the art to which the embodiments of the present disclosure belong. It should also be understood that terms, such as those defined in commonly used dictionaries, should be understood to have meanings consistent with their meaning in the context of the prior art, and unless specifically defined as herein, are not intended to be idealized or overly formalized.

To better understand the technical solutions described in the embodiments of the present disclosure, the concepts involved in the embodiments of the present disclosure are introduced below.

### 1. Model

For different rendering scenarios (such as scenarios of people walking, standing, etc.), each frame of the image can include multiple models, such as trees or mountains. Each model is generally composed of multiple vertex data.

### 2. Vertex Data

Each model is generally composed of multiple triangular planes, each of which is composed of three vertices. Therefore, vertex data can refer to a collection of vertices corresponding to the model.

### 3. Rendering Pipeline

For each frame of an image, the rendering pipeline can convert multiple input models into visible pixels to achieve image rendering. In the above process, the central processing unit (CPU) in the rendering pipeline can perform culling on the input model and send the culled input model to the graphic processing unit (GPU) in the rendering pipeline, which then renders the image based on the culled input model.

### 4. Rasterization

Rasterization refers to the process of converting the model into corresponding pixels.

When rendering an image through the rendering pipeline, there are a lot of redundancies in the input model data (which can also be understood as invalid data). For example, for the GFX benchmark, the model data actually associated with the image rendering content accounts for approximately 12% of the input model data. If the CPU does not eliminate invalid data in the model data, but directly sends the model data to the GPU, it causes the GPU to occupy a large amount of bandwidth resources and memory space when rendering images. Therefore, invalid data can be eliminated by the CPU to reduce resource usage.

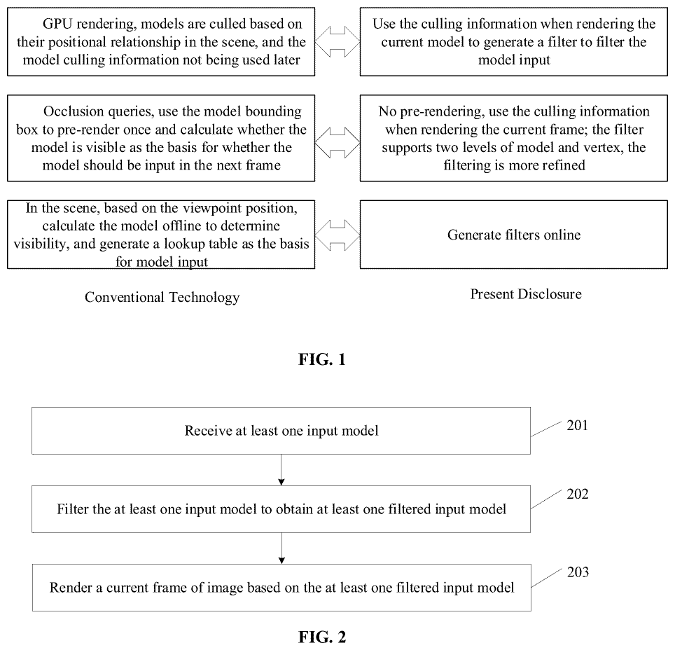

However, as shown in FIG. 1, in conventional technology, when the GPU is rendering an image, the CPU generally first culls the model based on its positional relationship. Since the culling information of the model is not used in subsequent operations, that is, the prior information of model culling in the rendered image frame is not used, the CPU needs to obtain the complete model data and perform culling processing. This takes up a lot of computing resources, resulting in a longer CPU processing cycle, which affects rendering efficiency.

To improve the rendering efficiency, in conventional technology, occlusion queries can be performed. More specifically, for the current image frame, after the model is input, a simple rendering is performed using a bounding box instead of the model to determine whether the model is occluded and culled, and the result is recorded as the basis for subsequent image frame rendering. For subsequent image frames, the recorded results are queried to determine whether the model needs to be rendered. However, in this process, in order to determine whether the model is occluded or not, an additional rendering action needs to be performed first, which reduces the rendering efficiency.

In addition, in conventional technology, an elimination index can be pre-established. More specifically, for the model in the current image frame, based on the position of the viewpoint (which can be understood as the position of the camera), the model that will be eliminated can be predicted, and an elimination index can be established as the basis for model input. When the viewpoint reaches the corresponding position, the eliminated model may not be loaded based on the elimination index. However, this process requires a large amount of offline calculation in advance, and the calculation accuracy is limited. This process can only be used as a rough culling process, and cannot finely cull the data, which affects the rendering effect.

In summary, for the current image rendering process, there is room for improvement on the rendering efficiency and rendering effect.

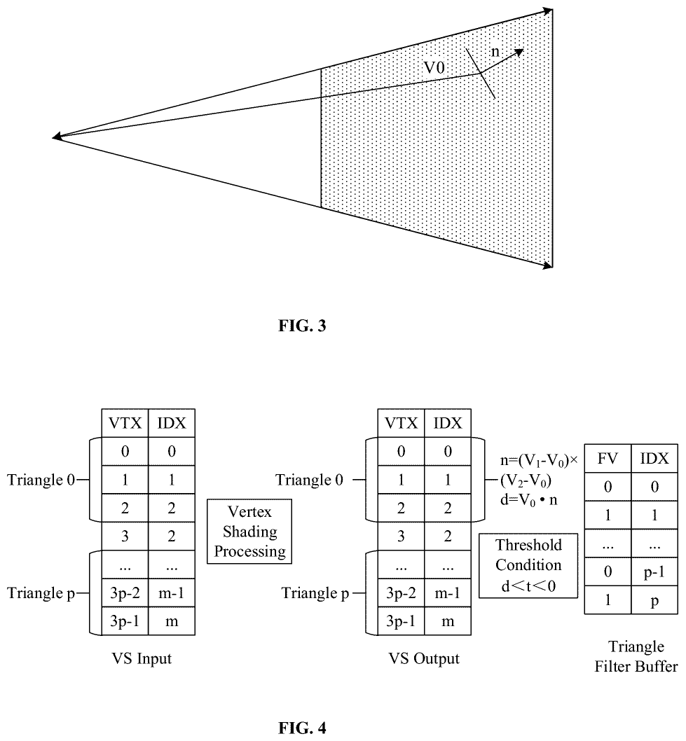

To improve the rendering efficiency and rendering effect for image rendering, an embodiment of the present disclosure provides an image rendering method. FIG. 2 is a flowchart of an exemplary image rendering method according to some embodiments of the present disclosure. The method can be applied to an electronic device. The method will be described in detail below.

201, obtaining at least one input model.

202, filtering the at least one input model to obtain at least one filtered input model, the filtering parameters used in the filtering being established based on data with an input model that has been eliminated in a rendered image frame.

203, rendering a current frame of image based on the at least one filtered input model.

In some embodiments, the electronic device may be any suitable device with image rendering capability, such as a server, a laptop, a tablet, a desktop computer, a mobile device, etc., which is not limited in the embodiments of the present disclosure.

In some embodiments, before the process at 201, the electronic device may establish the filtering parameters based on the elimination information in the rendered image frame such that the filtering parameters can be subsequently used to filter the input model in the unrendered image frame. That is, prior information of the rendered image frame can be used to render the subsequent image frames. In some embodiments, there may be a corresponding relationship between the input model and the filtering parameters in the image frame. That is, corresponding filtering parameter may be established for each input model. A plurality of filtering parameters can form a filter, and by establishing different combinations of filtering parameters, a filter for the input model can be formed.

In the embodiments of the present disclosure, on one hand, during the image rendering process, the filtering parameters of the model can be determined based on the information of the model being eliminated in the rendered image frame, and the model in the subsequent image frame can be filtered by the determined filtering parameters. In this way, the input of invalid model data (i.e., invisible parts) in the subsequent rendering process can be reduced, thereby improving rendering efficiency. On the other hand, by reducing the input of invalid data into the model, the use of computing and storage resources in the image rendering process can also be reduced, thereby reducing power consumption and improving energy efficiency.

Based on this, in some embodiments, the method for establishing the filtering parameters may include constructing initial filtering parameters corresponding to the input model; filtering the input model using the initial filtering parameters, and using the filtered input model for image rendering; and updating the corresponding filtering parameters based on the data that have input model already been eliminated during the image rendering process, and performing image rendering of subsequent image frames based on the updated filtering parameters.

In some embodiments, the current image frame and subsequent image frames may include a plurality of input models, such as 20. The number of input models in the image frame is not limited in the embodiments of the present disclosure.

In actual application, for each input model in the current image frame, the electronic device may construct the corresponding initial filtering parameters. Next, the constructed initial filtering parameters may be used to filter the plurality of input models in the current image frame to obtain a plurality of filtered input models. Subsequently, based on the plurality of filtered input models, the image rendering of the current image frame can be performed. The initial filtering parameters can be set based on experiences, which is not limited in the embodiments of the present disclosure.

During the image rendering process of subsequent image frames, the electronic device may periodically update the filtering parameters corresponding to the input model, and render subsequent image frames based on the updated filtering parameters. In this way, the frequency of updates can be reduced, thereby reducing the use of computing resources. Updating the filtering parameters may refer to updating the number, values, etc. of specific filtering parameters in the filter on the basis that the number and type of filters that have been established are valid, without rebuilding the filter. For example, during the rendering process of 10 image frames, the electronic device may update the filtering parameters corresponding to the input model in a cycle of 5 frames. That is, each time the filtering parameters corresponding to the input model are updated, the next five image frames can be rendered based on the updated filtering parameters, and then the next parameter update can be performed. That is, the electronic device can update the filtering parameters using the data that is eliminated from the input model in the 1^{st} and 6^{th} frames, and update the filtering parameters twice in total. Of course, the electronic device can also use 2 frames as a cycle. In this way, each time the filtering parameters corresponding to the input model are updated, the next two image frames can be rendered based on the updated filtering parameters. That is, the electronic device can update the filtering parameters using the data that are eliminated from the input model in the 1^{st}, 3^{rd}, 5^{th}, 7^{th} and 9^{th} frames, and update the filtering parameters five times in total.

In actual application, for data whose input model is eliminated in the current image frame, the electronic device may set a threshold to predict whether the input model in the subsequent image frame is eliminated, and then update the filtering parameters based on the prediction result.

Based on this, in some embodiments, periodically updating the corresponding filtering parameters based on the data that is eliminated from the input model during the image rendering process may include: updating the corresponding filtering parameters when the data eliminated by the input model in the current image frame meets a threshold condition, the threshold condition being related to the probability that the data whose input model is eliminated in the current image frame that will be eliminated in the input model in the next image frame after the current image frame.

The threshold condition may be used as a basis for whether the input model is visible in subsequent image frames. The threshold condition may be obtained from the relative relationship between the input model and the camera, such as the rotation relationship between the input model and the camera, which is not limited in the embodiments of the present disclosure.

In actual application, the image rendering may include different rendering processes. Therefore, the electronic device may set corresponding threshold conditions based on data whose input models are eliminated in different rendering processes, and update the corresponding filtering parameters based on the set threshold conditions.

More specifically, in some embodiments, periodically updating the corresponding filtering parameters based on the data that is eliminated from the input model during the image rendering process may include: updating the corresponding filtering parameters by using at least one piece of data that was excluded from the input model during a first processing, the first processing including at least one of a backface culling process, a frustum culling process, and a rasterization culling process.

Backface culling may refer to the process of culling the input model data behind the camera. Frustum calling may refer to the process of determining the to-be-culled data from the input model by setting a bounding box. Rasterization culling may refer to the process of determining the to-be-culled data from the input model by rasterizing the input model.

In order to improve the accuracy of model filtering, for each first processing process, the electronic device may set filtering parameters of two dimensions, that is, filters corresponding to two different filtering dimensions, to filter data of different dimensions.

More specifically, in some embodiments, the filtering parameters may include a first filtering parameter and a second filtering parameter. The first filtering parameter may be used to filter part of the data of the input model, and the second filtering parameter may be used to filter the input model. The data of the input model that is eliminated during the backface culling process may be used to update the first filtering parameter and/or the second filtering parameter. The data of the input model that is eliminated during the frustum culling process may be used to update the first filtering parameter and/or the second filtering parameter. The data of the input model that is eliminated during the rasterization culling process may be used to update the second filtering parameter. The first filtering parameter may correspond to a first filter for filtering part of the data in the input model, and the second filtering parameter may correspond to a second filter for filtering the input model as a whole. The update of the first filtering parameter and the second filtering parameter can be understood as the update of the established first filter and the second filter, and the numbers of the first filter and the second filter are not limited in the present disclosure.

In some embodiments, the second filtering parameter can be understood as a filtering parameter of the model dimension, that is, used to filter the entire input model. For example, when the data corresponding to the input model is completely eliminated in the subsequent image frame, the second filtering parameter may be used to filter out the input model and no longer serve as input data for subsequent image rendering. In addition, since the input model consists of a plurality of triangles, and each triangle is composed of three vertices. The first filtering parameter can be understood as a filtering parameter of the triangle dimension, which is used to filter the triangles corresponding to the input model, that is, the partial data corresponding to the input model. For example, when the triangle corresponding to the input model is eliminated in the subsequent image frame, the first filtering parameter can be used to filter out the corresponding triangle and no longer server as input data for subsequent image rendering.

In actual application, in the backface culling process, the electronic device may determine the to-be-culled data of the input model in the current image frame. Next, using the data of the input model that is eliminated in the current image frame and the threshold conditions corresponding to the backface elimination, whether the data that is eliminated by the input model in the current image frame will be eliminated in the next image frame or the following image frames after the current image frame may be predicted to obtained a prediction result. Subsequently, based on the prediction result, the first filtering parameter and the second filtering parameter corresponding to the input model may be updated.

When determining that the input model in the current image frame is eliminated, the electronic device may perform vertex shading processing on a plurality of input models in the current image frame to obtain the input model in the virtual camera coordinate system (i.e., a coordinate system established with the camera in the camera space as the origin). The above process can convert the vertex data coordinates corresponding to the input model into the vertex data coordinates in the camera space, and then the electronic device can perform backface culling processing on the input model under the virtual camera coordinates.

More specifically, for a triangle corresponding to the input model, as shown in FIG. 3, the electronic device may determine the normal vector n of the triangle and determine whether the triangle will be eliminated by calculating the dot product d between the vertex V₀ and the normal vector (equivalent to the cosine value of the angle between the vertex and the normal vector). If the dot product is less than 0, it may indicate that the triangle is facing away from the camera (where the eye is), and the triangle will be eliminated in the current image frame. If the dot product is equal to 0, it may indicate that the camera is perpendicular to the normal vector of the triangle, the triangle is invisible, and will be eliminated in the current image frame. If the dot product is greater than 0, it may indicate that the triangle is visible. In some embodiments, the normal vector n may be determined by using the following formula:

$$n = ( {V}_{1} - {V}_{0} ) \times ( {V}_{2} - {V}_{0} ) \qquad ( 1 )$$

where V₀, V₁, and V₂ represent the three vertices of the triangle respectively.

In addition, the electronic device may determine the dot product d by using the following formula:

$$d = {V}_{0} \cdot n \qquad ( 2 )$$

In the embodiments of the present disclosure, in order to predict the situation of the subsequent image frames, the electronic device may set a threshold condition corresponding to the backface culling process, which serves as a basis for the to-be-culled triangle in the next image frame or the subsequent image frames. In some embodiments, the threshold condition may be set based on the rotation relationship between the input model and the camera.

For example, assume that the camera and the model are rotated in the next image frame and the angle of rotation is greater than or equal to a, the triangles culled in the current image frame are visible in the next image frame, the electronic device may set the threshold condition t₁ for backface culling based on a, which can be set as t₁=cos(90+a). Take the frame per second (FPS) as 60 as an example, the value of a can be set to an integer multiple of the camera angular velocity/60. Generally, an angular velocity of 180 degrees per second can easily cause dizziness, therefore, the rotation angle of a single frame can be set to no more than 3°.

In actual application, in the process of backface culling, when the triangle corresponding to the input model in the current image frame is culled, if the dot product of the vertex of the triangle and the normal vector meets the threshold condition corresponding to the backface culling (i.e., d<t₁<0), the electronic device may predict that the triangle will be eliminated in the next image frame or the subsequent image frames, and update the corresponding filtering parameters. If the dot product of the vertex of the triangle and the normal vector does not meet the threshold condition (i.e., d≥t₁), the electronic device may predict that the triangle will not be culled in the next image frame or the subsequent image frames, and retain the current filtering parameters.

When the triangle corresponding to the input model is to be eliminated in the next image frame or in the subsequent image frames, the electronic device may update the first filtering parameter corresponding to the input model. In addition, if all triangles corresponding to the image rendering are to be eliminated in the image frame or in the subsequent image frames, the electronic device may also update the second filtering parameter corresponding to the input model.

For example, as shown in FIG. 4, assume that the input model includes p triangles; each triangle corresponds to three vertices (VTX) and indices (IDX). First, the electronic device may obtain p triangles in the virtual camera coordinate system by performing vertex processing on the p triangles. Next, the backface culling process may be performed on the p triangles in the virtual camera coordinates by using formulas (1) and (2) to determine the culled triangles in the current image frame. Subsequently, based on the threshold condition corresponding to the backface culling (which can also be referred to as the prediction filter), the parameters corresponding to the triangles filter buffer (i.e., the first filtering parameter) may be determined. In some embodiments, FV may be used to indicate whether the triangle is culled in the next image frame or in the subsequent image frames. For example, 0 may indicate that the triangle is culled in the next image frame or in the subsequent image frames, and 1 may indicate that the triangle is not culled in the next image frame or in the subsequent image frames. Of course, 1 may indicate that the triangle culled in the next image frame or in the subsequent image frames, and 0 may indicate that the triangle is not culled in the next image frame or in the subsequent image frames, which is not limited in the embodiments of the present disclosure.

In actual application, in the process of frustum culling, first, the electronic device may determine the to-be-culled data of the input model in the current image frame. Next, using the data of the input model that is eliminated in the current image frame and the threshold conditions corresponding to the frustum elimination, whether the data that is eliminated by the input model in the current image frame will be eliminated in the next image frame or the following image frames after the current image frame may be predicted to obtained a prediction result. Subsequently, based on the prediction result, the first filtering parameter and the second filtering parameter corresponding to the input model may be updated.

When determining the data of the input model eliminated in the current image frame, the electronic device may determine the input model in the virtual camera coordinate system. Next, the electronic device may perform frustum culling on the input model under the virtual camera coordinates.

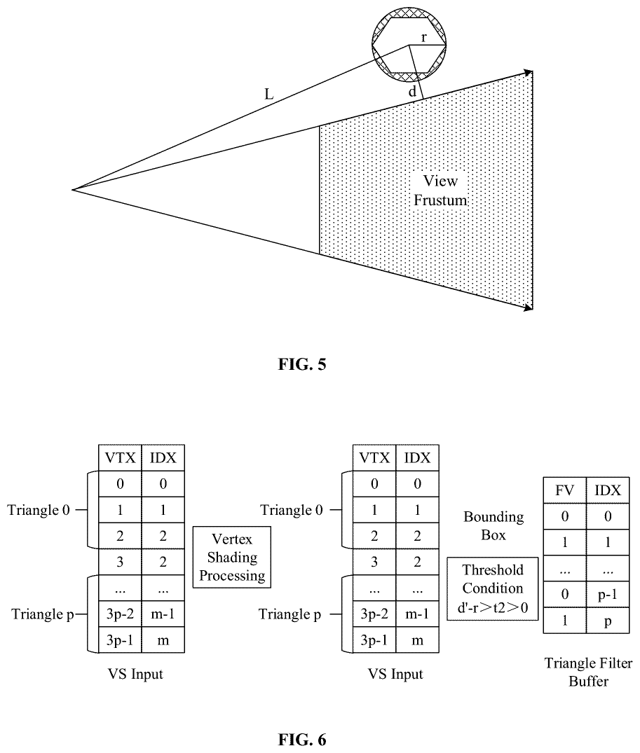

More specifically, as shown in FIG. 5, for the input model, the electronic device may set a spherical bounding box with a radius r to enclose the input model. Next, by calculating the distanced between the center of the bounding box and the six planes of the view frustum, whether the input model or the triangles of the input model will be culled may be determined. If the distance d′ is less than the radius r of the bounding box, it may indicate that the input model is inside the viewing frustum and will not be culled in the current image frame. If the distance d′ is equal to the radius r of the bounding box, it may indicate that the input model intersects with the viewing frustum, and the part of the input model (i.e., the triangle) outside the viewing frustum will be eliminated in the current image frame. If the distance d′ is equal to the radius r of the bounding box, in may indicate that the input model is outside the viewing frustum and the entire input model will be eliminated in the current image frame.

In the embodiments of the present disclosure, in order to predict the situation of the subsequent image frame, the electronic device may set the threshold condition corresponding to the frustum culling process, which serves as the basis for the input model or the to-be-culled triangle in the next image frame. For example, assume that the camera and the model rotate in the next image frame, and the rotation angle is greater than or equal to a, the input model or the triangles in the input model that are culled in the current image frame may be visible in the next image frame. In this way, the electronic device may set the threshold condition t₂ for the backface culling as t₂=L sin α−r based on α, the radius r, and the distance L between the center of the bounding box and the camera. For example, when α is 15°, t₂=L sin 15−r.

In actual application, in the process of frustum culling, when the input model or triangle in the current image frame is culled, if the distance d′ and radius r meet the threshold conditions corresponding to the frustum culling (i.e., d′−r>t₂>0), then the electronic device may predict that the input model or triangle will be eliminated in the next image frame or the subsequent image frames, and update the corresponding filtering parameters. If the distance d′ and radius r meet the threshold conditions corresponding to the frustum culling (i.e., d′−r≤t₂), the electronic device may predict that the input model or triangle will not be eliminated in the next image frame or the subsequent image frames, and retain the current filtering parameters.

It should be noted that, in the above process, when the triangle is to be eliminated in the next image frame or the subsequent image frames, the electronic device may update the first filtering parameter corresponding to the input model. In addition, when the input model will be culled in the next image frame or the subsequent image frames, or when a plurality of triangles corresponding to the input model will be eliminated in the next image frame or the subsequent image frames, the electronic device may update the second filtering parameter corresponding to the input model.

For example, as shown in FIG. 6, assume that the input model includes p triangles; each triangle corresponds to three vertices (VTX) and indices (IDX). First, the electronic device may obtain p triangles in the virtual camera coordinate system by performing vertex processing on the p triangles. Next, the frustum culling process may be performed on the p triangles in the virtual camera coordinates by using formulas (1) and (2) to determine the culled triangles in the current image frame. Subsequently, based on the threshold condition corresponding to the frustum culling (d′−r>t₂>0), the parameters in the triangles filter buffer (i.e., the first filtering parameter) may be updated. In some embodiments, FV may be used to indicate whether a triangle is to be culled in the next image frame or in the subsequent image frames.

In actual application, in the process of rasterization culling, the electronic device may perform rasterization processing on the input model and establish a mapping table between the input model and the eliminated data after the rasterization processing to determine whether the input model is visible in the next image frame or the subsequent image frames.

More specifically, in some embodiments, the at least one first processing may include the rasterization culling process, and updating the corresponding filtering parameters by using at least one piece of data that is eliminated from the input model in the first processing process may include: determining a plurality of input models corresponding to the current image frame; in the process of rasterization culling, establishing a mapping relationship between the culled data and the plurality of input models; and when all the data corresponding to the input model are eliminated, updating the filtering parameters corresponding to the input model based on the mapping relationship.

In actual application, in the process of rasterization culling, the electronic device may perform rasterization processing on the plurality of input models and determine the fragments corresponding to each input model, perform occlusion culling processing on the fragments corresponding to each input model, and establish a mapping table between the input model and the culled fragments. In some embodiments, the fragment may include partial data obtained by dividing the data corresponding to the input model. When the fragments corresponding to the input model are eliminated, it may indicate that the input model is not visible in the next image frame or the subsequent image frames, and the electronic device may update the second filtering parameter corresponding to the input model. That is, the electronic device can determine the number of eliminated fragments corresponding to the input model based on the mapping relationship, and then determine whether the input model will be completely eliminated.

In actual application, when the input model and/or camera moves quickly, the difference between the adjacent image frames will be relatively large. In this case, subsequent image rendering based on the filtering parameters established in the current frame may cause errors in the rendering results, thus affecting the rendering effect. In order to control the error to balance the performance and rendering effect, the electronic device may set the timeliness of the filtering parameters.

Based on this, in some embodiments, the image rendering method may also include: configuring timeliness information for the filtering parameters, the timeliness information being determined based on the positional relationship between the camera and the at least one input model in the camera space.

In some embodiments, filtering the at least one input model to obtain the at least one filtered input model may include: obtaining the timeliness information of the filtering parameters; when the timeliness information indicates that the filtering parameters are in a valid state, filtering the at least one input model by using the filtering parameters to obtain the at least one filtered input model.

In some embodiments, the timeliness information may be determined based on the rotation angle α between the camera and the input model. For example, when α=150 and the rotation angle of a single frame does not exceed 3°, it may indicate that the filtering parameters established this time can be used in the image rendering processing within 5 frames. That is, the timeliness information is configured to be 5 frames at most.

After configuring the timeliness information for the filtering parameters corresponding to the input model, the electronic device may obtain the timeliness information of the filtering parameters and perform image rendering of subsequent image frames based on the filtering parameters when the filtering parameters are in a valid state. More specifically, if the input model is not visible in the subsequent image frame, the electronic device may filter the input model using the second filtering parameter to eliminate the input model; if the input model is visible in the subsequent image frame, the electronic device may filter the input model using the first filtering parameter to eliminate invisible triangles in the input model.

In actual application, when the actual rotation angle between the camera and the input model exceeds the rotation angle α, the electronic device may reset the filtering parameters to ensure the rendering effect of the image.

More specifically, in some embodiments, the image rendering method may also include: re-establishing the filtering parameters when the timeliness information indicates that the filtering parameters are in an invalid state; filtering the at least one input model by using the re-established filtering parameters to obtain the at least one filtered input model.

In actual application, when the timeliness information indicates that the filtering parameters are in an invalid state, it may indicate that the actual rotation angle between the camera and the input model exceeds the rotation angle α. In this way, if image rendering is continued based on the filtering parameters established this time, errors can be introduced in the rendering results. Therefore, when the filtering parameters are in an invalid state, the electronic device may re-establish the filtering parameters based on the data whose input model is eliminated in the current image frame, and render the subsequent image frames based on the re-established filtering parameters. That is, the electronic device can periodically re-establish the filtering parameters for the input model based on the timeliness information to ensure the image rendering effect.

For example, assume the timeliness information s is set to 5 frames, within one cycle, the electronic device may establish filtering parameters based on the data that is eliminated from the input model in the first frame, and perform image rendering for the subsequent 5 frames based on the established filtering parameters. In the next cycle, the filtering parameters are re-established based on the data that was eliminated from the input model in the s+1^{th} frame, and perform image rendering of the next 5 frames based on the re-established filtering parameters.

In actual application, during the image rendering process, the electronic device may also update the timeliness information in real time.

Based on this, in some embodiments, the image rendering method may also include: updating the timeliness information based on the positional relationship between the camera and the input model in the camera space.

In actual application, the positional relationship may include rotation angle or distance, etc. For example, in a game scenario, the timeliness information may be updated by detecting the mouse movement frequently. In another example, the timeliness information may be updated by detecting a change in viewing angle. The type of positional relationship is not limited in the present disclosure.

When the input model and/or camera moves quickly, the positional relationship between the input model and the camera will change significantly. At this time, the electronic device needs to update the timeliness information to reduce the number of frames that the established filtering parameters can be used in subsequent image rendering processes. The timeliness information may be updated periodically, and the value of the period can be set as needed.

For example, when the actual rotation angle between the input model and the camera changes significantly and exceeds the rotation angle α, the electronic device may update the timeliness information from 5 frames to 3 frames, and perform image rendering for the next 3 frames based on the filtering parameters.

In addition, in the process of updating the filtering parameters, the electronic device may update the filtering parameters in real time based on changes in the filtering parameters.

In some embodiments, the timeliness information may be updated based on the filtering parameters.

In actual application, since the change of the filtering parameters between adjacent image frames can reflect the difference of the data eliminated from the input model between adjacent image frames, the electronic device may update the timeliness information based on the change of the filtering parameters. In the scenario where the filtering parameters are re-established multiple times, the electronic device may update the timeliness information based on the updated filtering parameter change range after each establishment of the filtering parameters. That is, the electronic device can periodically update the timeliness information based on the filtering parameters.

If the filtering parameters change significantly, it may indicate that the difference between adjacent image frames is relatively large, and the subsequent image frame rendering based on the filtering parameters established for the current frame may cause errors in the rendering results. Therefore, in order to ensure the rendering effect, the electronic device may update the timeliness information to reduce the number of frames that the established filtering parameters can be used in the subsequent image rendering process.

For example, after the filtering parameters are established, if the change range of the filtering parameters after the first update is greater than a preset threshold, the electronic device may update the timeliness information from 5 frames to 4 frames, and perform image rendering of subsequent 4 frames based on the filtering parameters.

In addition, if the change in the filtering parameters is small, it may indicate that the difference between adjacent image frames is relatively small, and the electronic device can increase the number of frames in which the filtering parameters established this time can be used in the subsequent image rendering process to reduce the re-establishment frequency of the filtering parameters. For example, after the filtering parameters are established, if the change range of the filtering parameters after the first update is greater than the preset threshold, the electronic device may update the timeliness information from 5 frames to 7 frames, and perform image rendering for the subsequent 7 frames based on the filtering parameters.

In actual application, assume that the time validity information of the filtering parameters corresponding to the input model in the image frame is 20 frames, it means that the filter corresponding to the filtering parameters is in a valid state during the subsequent 20 frames of image rendering, and the filter needs to be re-established after 20 frames. In this case, if the electronic device updates the filtering parameters of the filter using the empirical data of each frame of image rendering within the effective time of the filter, the filter needs to be updated 20 times. If the electronic device updates the filtering parameters of the filter with a period of 2 frames, the filter needs to be updated 10 times. In this way, during the effective time of the filter, periodically updating the filtering parameters can reduce the update frequency, thereby reducing the occupation of computing resources.

Consistent with the present disclosure, the image rendering method includes: obtaining at least one input model; filtering the at least one input model to obtain at least one filtered input model, the filtering parameters used in the filtering being established based on data of the input model that has been eliminated in a rendered image frame; and rendering a current frame of image based on the at least one filtered input model. By using the technical solutions provided in the embodiments of the present disclosure, on one hand, during the process of image rendering, the filtering parameters of the model can be determined based on the information of the model being eliminated in the rendered image frame, and the model in the subsequent image frame can be filtered using the determined filtering parameters. In this way, the input of invalid model data in the subsequent rendering process can be reduced, thereby improving rendering efficiency. On the other hand, reducing the input of invalid data in the model can also reduce the use of computing and storage resources during image rendering, thereby reducing power consumption and improving energy efficiency.

The present disclosure is further described in detail below in conjunction with application examples.

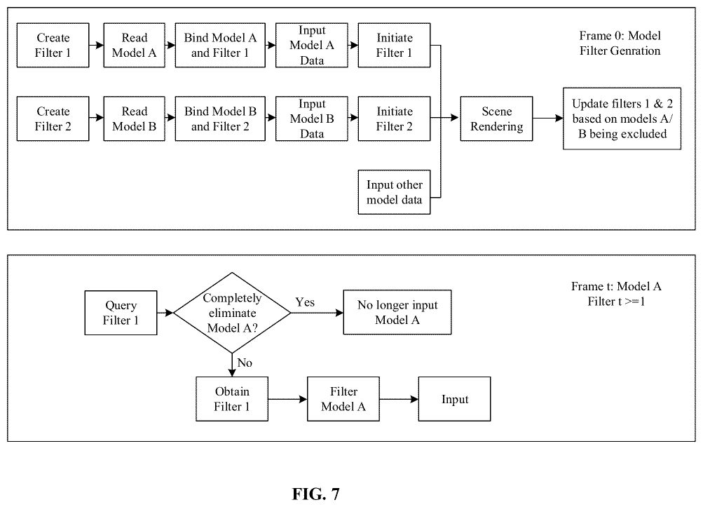

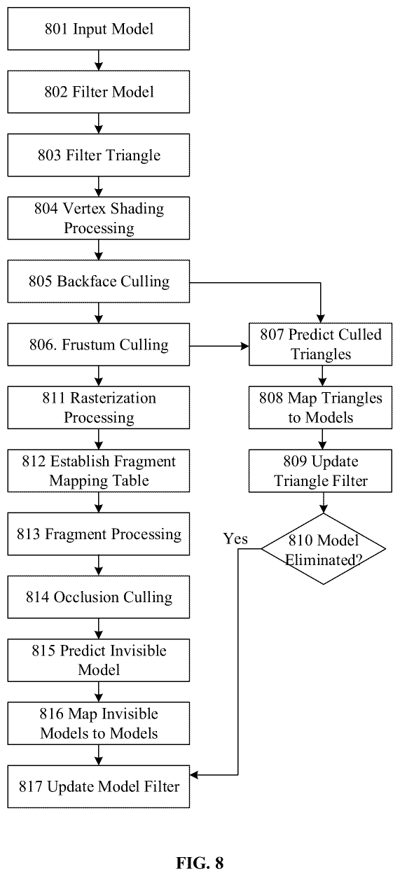

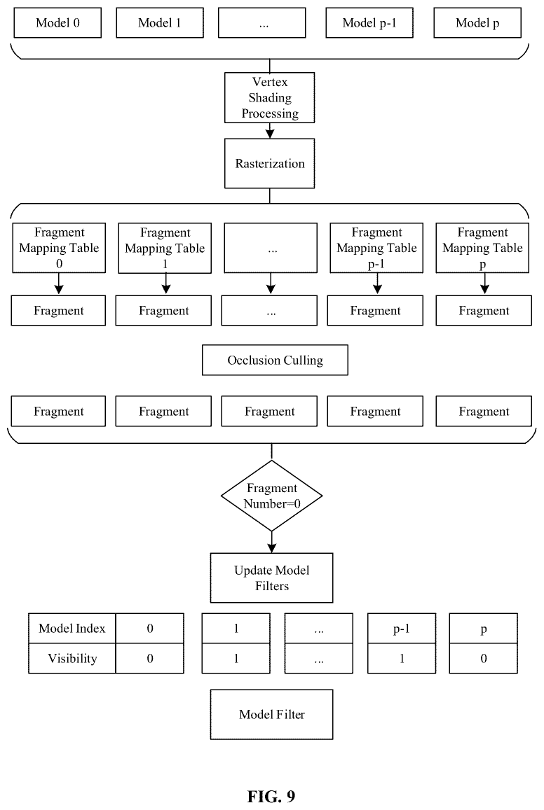

An embodiment of the present disclosure provides a rendering model filtering solution based on prior information. More specifically, as shown in FIG. 7, based on the information of the model being eliminated in the current frame (i.e., frame 0), the filter (i.e., the filtering parameters described above) corresponding to the model is established. That is, after establishing filter 1 and filter 2 for model A and model B in frame 0, data corresponding to model A and data corresponding to model B can be input into filter 1 and filter 2 respectively to realize the initiation of filter 1 and filter 2. Next, based on the data eliminated from model A and model B, filter 1 and filter 2 can be updated. When the subsequent image frame (i.e., frame t) is rendered, the model can be filtered using the established filter to reduce the input of invisible information in the model. For example, whether model A is completed eliminated can be determined by querying filter 1. If model A is completely eliminated, model A is no longer input in subsequent image rendering. If model A is not completely eliminated, model A is filtered through filter 1.

In actual application, the process of filtering the rendering model based on prior information may include the following processes.

801, feeding the model into a rendering pipeline (which can be expressed as input).

802, establishing an initial model filter and filtering the input model based on the initial model filter (which can be expressed as filter input models).

In some embodiments, the model filter may be used to filter the model.

If the model is set as invisible in the initial model filter, the model may not be input to the rendering pipeline. If the model is not set as invisible in the initial model filter, the process at 803 can be performed.

803, establishing an initial triangle filter and filtering the input model based on the initial triangle filter (which can be expressed as filter input triangles).

In actual application, the triangles in the input model can be filtered based on the initial triangle filter. More specifically, for the triangles set as invalid in the initial triangle filter, a culling operation can be performed to obtain a filtered model.

804, performing vertex shading operation (which can be expressed as vertex processing) on the filtered model to obtain the model under the virtual camera coordinates.

805, performing backface culling, and then perform the process at 807.

By performing backface culling, content behind the camera in the current frame can be culled.

806, performing view frustum culling, and then perform the process at 807.

It should be noted that the backface culling process and the view frustum culling process can be performed in no particular order. That is, after the backface culling process is performed through processes 805, and 807-810, the frustum culling process can be performed through processes 806, and 807-810. Or, after the frustum culling process is performed through processes 806, and 807-810, the backface culling process can be performed through processes 805, and 807-810. After the backface culling process and the frustum culling process are completed, process at 811 can be performed to realize the rasterization culling process.

806, predicting culled triangled (which can be expressed culling triangles predict).

In some embodiments, based on the content culled in the current frame, the triangles what will be culled in the next frame can be predicted.

807, mapping the predicted triangle with the input model (which can be expressed as map input triangle).

808, updating the triangle filter (which can be expressed as update input triangle filter).

809, determining whether the model is eliminated (which can be expressed as culling triangle predict).

In actual application, if tall triangles corresponding to the input model are eliminated, the process at 817 can be performed; otherwise, frustum culling can be performed.

811, performing rasterization processing (which can be expressed as rasterizer).

In some embodiments, the filtered model can be rasterized to obtain a rasterized model.

812, creating a fragment offset table.

For the model after rasterization, the corresponding fragment mapping table of each model can be established after rasterization, where each model corresponds to the fragment mapping table in a one-to-one relationship.

813, performing fragment processing.

814, performing occlusion culling.

In some embodiments, occlusion culling can be performed on all fragments corresponding to the model to determine the fragments that will be culled.

815, predicting an invisible model (which can be expressed as invisible model prediction).

In actual application, based on the number of fragments stored in the fragment mapping table, whether the model is visible can be determined. More specifically, if all corresponding fragments in the fragment mapping table are eliminated, the corresponding model is invisible; otherwise, the corresponding model is visible.

816, mapping the predicted model and the input model (which can be expressed as map input models).

817, updating model filter (which can be expressed as update input models).

For example, as shown in FIG. 9, the process of rasterization culling may include: performing vertex shading on p models to obtain p models under the virtual camera coordinates; and establishing the fragment mapping table for each model after performing rasterization on the p models under the virtual camera coordinates. After performing an occlusion test on the fragments corresponding to the model, if the number of fragments stored in a fragment mapping table becomes 0, it may indicate that the corresponding model can be culled in the occlusion culling. Therefore, the corresponding model can be set to invisible in the model filter and update the model filter. For example, the visibility of model 0 in the model filter can be set to 0 (i.e., invisible), and the visibility of model 1 in the model filter can be set to 1 (i.e., visible).

In addition, when the input model or viewpoint moves quickly, using model filters and/or triangle filters may cause errors in the rendering results. From the perspective of practical applications, this error is generally acceptable. For example, OpenGL's occlusion queries technology generally queries the occlusion state of the current image frame and uses the query results for rendering subsequent frames.

In the embodiments of the present disclosure, in order to control the error to balance performance and rendering effect, the timeliness (that is, the timeliness information described above) of the model filter and/or triangle filter may also be set. In some embodiments, the timeliness can be expressed by the step size parameter s.

When subsequent image frames are rendered, the timeliness of the model filter and/or triangle filter may be determined. If the model filter is valid, the model filter may be used to filter the input model. If the model is not visible and the triangle filter is valid, the input model may be filtered using the triangle filter to eliminate the triangles in the model that are set as invisible in the triangle filter. If the model filter and/or triangle filter is invalid, the model filter and/or the triangle filter may be re-established, and the image may be rendered based on the re-established model filter and/or the triangle filter.

In the embodiments of the present disclosure, the filter corresponding to the model can be established online by using the culling prior information of the current frame during image rendering. In this process, no additional processing such as pre-rendering is required, which can ensure rendering efficiency.

In addition, the filter may be established to support both model and vertex levels. In this way, when the model in the subsequent image frame is filtered based on the model obtained by eliminating the prior information, the input of the invisible part of the model can be filtered out more finely, thereby improving the rendering efficiency.

Based on the above-described embodiments, the present disclosure further provides an image rendering device. The image rendering device includes various modules that can be implemented by a processor in an electronic device, or logic circuits. In some embodiments, the processor may be a central processing unit (CPU), a micro processing unit (MPU), a digital signal processor (DSP), or a field programmable gate array (FPGA).

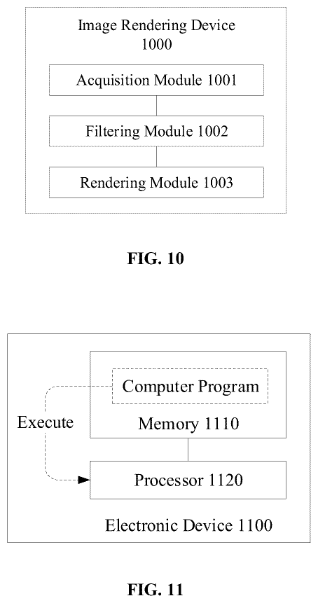

FIG. 10 is a schematic structural diagram of an exemplary image render device according to some embodiments of the present disclosure. As shown in FIG. 10, the image rendering device 1000 includes an acquisition module 1001, a filtering module 1002, and a rendering module 1003.

The acquisition module 1001 may be configured to obtain at least one input model.

The filtering module 1002 may be configured to filter the at least one input model to obtain the at least one input model after filtering. The filtering parameters used in the filtering may be established based on the data of the input that has been eliminated in the rendered image frame.

The rendering module 1003 may be configured to render the current frame of image based on the at least one filtered input model.

In some embodiments, the filtering module 1002 may be configured to construct the initial filtering parameters corresponding to the input model; filter the input model using the initial filtering parameters, and use the filtered input model for image rendering; and periodically update the corresponding filtering parameters based on the data that is eliminated from the input model during the image rendering process, and perform image rendering of subsequent image frames based on the updated filtering parameters.

In some embodiments, the filtering module 1002 may be configured to update the corresponding filtering parameters when the to-be-eliminated data from the input model in the current image frame meets the threshold condition. The threshold condition may be related to the probability that the data whose input model is eliminated in the current image frame will be eliminated in the input model in the next image frame after the current image frame.

In some embodiments, the filtering module 1002 may be configured to update the corresponding filtering parameters using at least one piece of data that is excluded from the input model during the first process. The at least one first processing may include at least one of a backface culling process, a frustum culling process, and a rasterization culling process.

In some embodiments, the at least one first processing may include rasterization culling. The filtering module 1002 may be configured to determine a plurality of input models corresponding to the current image frame; during the rasterization culling process, establish a mapping relationship between the culled data the plurality of input models; and when all data corresponding to the input model are eliminated, update the second filtering parameter corresponding to the input model based on the mapping relationship.

In some embodiments, the acquisition module 1001 may be further configured to configure timeliness information for the filtering parameters, the timeliness information being determined based on the positional relationship between the camera in the camera and the at least one input model.

Correspondingly, the filtering module 1002 may be configured to obtain the timeliness information of the filtering parameters, and filter the at least one input model using the filtering parameters to obtain the at least one filtered input model when the timeliness information indicates that the filtering parameters are in a valid state.

In some embodiments, the filtering module 1002 may be further configured to re-establish the filtering parameters when the timeliness information indicates that the filtering parameters are in an invalid state, and filter the at least one input model using the re-established filtering parameters to obtain the at least one filtered input model.

In some embodiments, the filtering module 1002 may be further configured to periodically update the timeliness information based on the positional relationship between the camera and the input model in the camera space, or periodically update the timeliness information based on the filtering parameters.

It should be noted here that: the description of the apparatus embodiments is similar to the description of the method embodiments, and has similar beneficial effects as the method embodiments. For technical details not disclosed in the apparatus embodiments of the present disclosure, references can be made to the description of the method embodiments of the present disclosure for understanding.

It should be noted that, in the embodiment of the present disclosure, if the above image rendering method is implemented in the form of a software function module and sold or used as a standalone product, it can also be stored in a computer-readable storage medium. Based on this understanding, the technical solutions of the embodiments of the present disclosure or the part that contributes to related technologies can be embodied in the form of software products. The computer software products are stored in the storage medium and include a plurality of program instructions to cause an electronic device (which may be a smart phone with a camera, a tablet computer, etc.) to execute all or part of the image rendering methods described in various embodiments of the present disclosure. The computer-readable storage medium includes: a U disk, a mobile hard disk, a read-only memory (ROM), a magnetic disk or an optical disk, and other media capable of storing program codes. Thus, the embodiments of the present application are not limited to any specific combination of hardware and software.

Correspondingly, the present disclosure further provides a computer-readable storage medium, on which a computer program is stored, and when the computer program is executed by a processor, the steps in any one of the image rendering methods described in the foregoing embodiments are implemented.

Correspondingly, the present disclosure further provides a chip. The chip includes a programmable logic circuit and/or program instructions, and when the chip is running, it is used to implement any one of the image rendering methods in the embodiments in the present disclosure.

Correspondingly, the present disclosure further provides a computer program product, which is used to implement the steps in any one of the image rendering methods in the foregoing embodiments when the computer program product is executed by a processor of an electronic device.

Based on the same technical concept, the present disclosure further provides an electronic device for implementing the image rendering method described in the above method embodiments. FIG. 11 is a schematic hardware diagram of an exemplary electronic device according to some embodiments of the present disclosure. As shown in FIG. 11, the electronic device 1100 includes a memory 1110 and a processor 1120. The memory 1110 stores a computer program that can run on the processor 1120. When the computer program is executed by the processor 1120, the steps in any one of the methods in the embodiments of the present disclosure are implemented.

The memory 1110 is configured to store program instructions and applications executable by the processor 1120, and also cache data to be processed or processed by the processor 1120 and various modules in the electronic device (for example, image data, audio data, voice communication data, and video communication data), which can be realized by flash memory (FLASH) or random-access memory (RAM).

When the processor 1120 executes the program instructions, the steps of any one of the image rendering methods described above are implemented. The processor 1120 generally controls the overall operation of the electronic device 1100.

The above-described processor may be at least one of an application-specific integrated circuit (ASIC), a digital signal processor (DSP), a digital signal processing device (DSPD), a programmable logic device (PLD), a field programmable gate array (FPGA), a central processing unit (CPU), a controller, a microcontroller, or a microprocessor. It should be understood that the electronic device implementing the above processor function may also be another device, which is not specifically limited in the embodiment of the present disclosure.

The above-described computer storage medium/memory may be a storage medium/memory such as a read-only memory (ROM), a programmable read-only memory (PROM), an erasable programmable read-only memory (EPROM), an electrically erasable programmable read-only memory (EEPROM), a magnetic random-access memory (FRAM), a Flash memory, a magnetic surface memory, an optical disk, and a compact disc read-only memory (CD-ROM). The above-described computer storage medium/memory may also be various electronic devices including one or any combination of the above-described memories, such as a mobile phone, a computer, a tablet device, and a personal digital assistant, etc.

It should be noted that the descriptions of the above storage medium and device embodiments are similar to the description of the above method embodiments, and have similar beneficial effects to those of the method embodiments. For technical details not disclosed in the storage medium and device embodiments of the present disclosure, reference can be made to the description of the method embodiments of the present disclosure for understanding.

It should be understood that reference throughout the specification to “one embodiment” or “an embodiment” means that a particular feature, structure, or characteristic related to the embodiment is included in at least one embodiment of the present disclosure. Thus, appearances of “in one embodiment” or “in an embodiment” in various places throughout the specification are not necessarily referring to the same embodiment. Furthermore, the particular features, structures or characteristics may be combined in any suitable manner in one or more embodiments. It should be understood that, in various embodiments of the present disclosure, the sequence numbers of the above-described processes do not mean the order of execution, which should be determined by its functions and internal logic, and should not constitutes any limitation on the implementation in the embodiments of the present disclosure. The sequence numbers of the above embodiments of the present disclosure are for description only, and do not represent the advantages and disadvantages of the embodiments.

It should be noted that, in the specification, the term “comprising”, “including” or any other variation thereof is intended to cover a non-exclusive inclusion such that a process, method, article, or apparatus comprising a set of elements includes not only those elements, but also includes other elements not expressly listed, or elements inherent in the process, method, article, or device. Without further limitations, an element defined by the phrase “comprising a . . . ” does not preclude the presence of additional identical elements in the process, method, article, or apparatus comprising that element.

In the embodiments of the present disclosure, the apparatuses and methods may be implemented in other ways. The apparatus embodiments described above are only illustrative. For example, the division of the units is only a logical function division. In actual implementation, there may be other division methods, that is, multiple units or components can be combined, or may be integrated into another system, or some features may be ignored, or not implemented. In addition, the mutual coupling, or direct coupling, or communication connection between various components shown or discussed may be through some interfaces, and the indirect coupling or communication connection of devices or units may be in electrical, mechanical, or other form.

The units described above as separate components may or may not be physically separated. The components displayed as units may or may not be physical units, and may be located in one place or distributed to multiple network units. Part or all of the units may be selected according to actual needs to achieve the objective of the embodiment of the present disclosure.

In addition, each functional unit in each embodiment of the present disclosure may be integrated into one processing unit, or each unit may be used as a single unit, or two or more units may be integrated into one unit. The integration of the units may be realized in the form of hardware or combination of hardware and software function modules.

Alternatively, if the integrated units of the present disclosure are realized in the form of software function modules and sold or used as standalone products, they can also be stored in a computer-readable storage medium. Based on this understanding, the technical solutions of the embodiments of the present disclosure or the part that contributes to related technologies can be embodied in the form of software products. The computer software products are stored in a storage medium and include program instructions to cause the equipment automatic test line or a processor to execute all or part of the methods described in various embodiments of the present disclosure. The storage medium includes various media capable of storing program codes such as removable storage devices, ROMs, magnetic disks, or optical disks.

The methods in the embodiments of the present disclosure can be combined arbitrarily to obtain new method embodiments under the condition of no conflict. The features disclosed in several method or apparatus embodiments provided in the present disclosure may be combined arbitrarily without conflict to obtain new method embodiments or apparatus embodiments.

The above description of the disclosed embodiments enables those skilled in the art to implement or use the present disclosure. Various modifications to the embodiments will be obvious to those skilled in the art, and the general principles defined herein can be implemented in other embodiments without departing from the spirit or scope of the present disclosure. Therefore, this application will not be limited to the embodiments shown in the specification, but should conform to the broadest scope consistent with the principles and novelties disclosed in the specification.

What is claimed is:

1. An image rendering method comprising:
receiving one or more input models;
filtering the one or more input models to obtain one or more filtered input models, a plurality of filtering parameters used in the filtering being established based on data that have an input model already been eliminated in a rendered image frame; and
rendering a current image frame based on the one or more filtered input models.

2. The method of claim 1, wherein a method for establishing the filtering parameters includes:
establishing initial filtering parameters corresponding to the input model;
filtering the input model using the initial filtering parameters, and using the filtered input model for image rendering; and
updating the corresponding filtering parameters based on the data of the input model that has already been eliminated during the image rendering process, and performing image rendering on a subsequent image frame based on the updated filtering parameters.

3. The method of claim 2, wherein updating the corresponding filtering parameters based on the data of the input model that has already been eliminated during the image rendering process includes:
updating the corresponding filtering parameters when the data of the input model that has been eliminated in the current image frame meets a threshold condition, the threshold condition being related to a probability of the data being eliminated in the subsequent image frame after the current image frame.

4. The method of claim 2, wherein updating the corresponding filtering parameters based on the data of the input model that has already been eliminated during the image rendering process includes:
updating the corresponding filtering parameters using the data of the input module that has already been eliminated during one of more first processes, the one or more first process including one or more of a backface culling process, a frustum culling process, and a rasterization culling process.

5. The method of claim 4, wherein:
the filtering parameters includes a first filtering parameter and a second filtering parameter, the first filtering parameter being used to filter part of data of the input model, the second filtering parameter being used to filter the input model;
the data of the input model that has been eliminated during the backface culling process is used to update the first filtering parameter and/or the second filtering parameter;
the data of the input model that has been eliminated during the frustrum culling process is used to update the first filtering parameter and/or the second filtering parameter; and
the data of the input model that has been eliminated during the rasterization culling process is used to update the second filtering parameter.

6. The method of claim 4, wherein:
the one or more first processes includes the rasterization culling process; and
updating the corresponding filtering parameters using data of the input model that has been eliminated during the one of more first processes includes:
determining the plurality of input models corresponding to the current image frame;
establishing a mapping relationship between the eliminated data and the plurality of input models during the rasterization culling process; and
when all data corresponding to the input models are eliminated, updating the second filtering parameter corresponding to the input models based on the mapping relationship.

7. The method of claim 1 further comprising:
configuring the filtering parameters with timeliness information, the timeliness information being determined based on a positional relationship between a camera and the one or more input models in a camera space, wherein:
filtering the one or more input models to obtain the one or more filtered input models include:
obtaining the timeliness information of the filtering parameters; and
when the timeliness information indicates that the filtering parameters are in a valid state, filtering the one or more input models using the filtering parameters to obtain the one or more input models.

8. The method of claim 7 further comprising:
when the timeliness information indicates that the filtering parameters are in an invalid state, re-establishing the filtering parameters; and
filtering the one or more input models using the re-established filtering parameters to obtain the one or more filtered input models.

9. The method of claim 7 further comprising:
updating the timeliness information based on the positional relationship between the camera and the input model in the camera space; or
updating the timeliness information based on the filtering parameters.

10. An image rendering device comprising computer readable storage medium storing computer instructions, when executed by one or more processors, the computer instructions implement an image rendering method, comprising:
receiving one or more input models;
filtering the one or more input models to obtain one or more filtered input models, a plurality of filtering parameters used in the filtering being established based on data that have an input model already been eliminated in a rendered image frame; and
rendering a current image frame based on the one or more filtered input models.

11. The image rendering device of claim 10, wherein a method for establishing the filtering parameters includes:
establishing initial filtering parameters corresponding to the input model;
filtering the input model using the initial filtering parameters, and using the filtered input model for image rendering; and
updating the corresponding filtering parameters based on the data of the input model that has already been eliminated during the image rendering process, and performing image rendering on a subsequent image frame based on the updated filtering parameters.

12. The image rendering device of claim 11, wherein updating the corresponding filtering parameters based on the data of the input model that has already been eliminated during the image rendering process includes:
updating the corresponding filtering parameters when the data of the input model that has been eliminated in the current image frame meets a threshold condition, the threshold condition being related to a probability of the data being eliminated in the subsequent image frame after the current image frame.

13. The image rendering device of claim 11, wherein updating the corresponding filtering parameters based on the data of the input model that has already been eliminated during the image rendering process includes:
updating the corresponding filtering parameters using the data of the input module that has already been eliminated during one of more first processes, the one or more first process including one or more of a backface culling process, a frustum culling process, and a rasterization culling process.

14. The image rendering device of claim 13, wherein:
the filtering parameters includes a first filtering parameter and a second filtering parameter, the first filtering parameter being used to filter part of data of the input model, the second filtering parameter being used to filter the input model;
the data of the input model that has been eliminated during the backface culling process is used to update the first filtering parameter and/or the second filtering parameter;
the data of the input model that has been eliminated during the frustrum culling process is used to update the first filtering parameter and/or the second filtering parameter; and
the data of the input model that has been eliminated during the rasterization culling process is used to update the second filtering parameter.

15. The image rendering device of claim 13, wherein:
the one or more first processes includes the rasterization culling process; and
updating the corresponding filtering parameters using data of the input model that has been eliminated during the one of more first processes includes:
determining the plurality of input models corresponding to the current image frame;
establishing a mapping relationship between the eliminated data and the plurality of input models during the rasterization culling process; and
when all data corresponding to the input models are eliminated, updating the second filtering parameter corresponding to the input models based on the mapping relationship.

16. The image rendering device of claim 10, further comprising:
configuring the filtering parameters with timeliness information, the timeliness information being determined based on a positional relationship between a camera and the one or more input models in a camera space, wherein:
filtering the one or more input models to obtain the one or more filtered input models include:
obtaining the timeliness information of the filtering parameters; and
when the timeliness information indicates that the filtering parameters are in a valid state, filtering the one or more input models using the filtering parameters to obtain the one or more input models.

17. The image rendering device of claim 16, further comprising:
when the timeliness information indicates that the filtering parameters are in an invalid state, re-establishing the filtering parameters; and
filtering the one or more input models using the re-established filtering parameters to obtain the one or more filtered input models.

18. The image rendering device of claim 16, further comprising:
updating the timeliness information based on the positional relationship between the camera and the input model in the camera space; or
updating the timeliness information based on the filtering parameters.
